(19) United States
(12) Patent Application Publication
(10) Pub. No.: US 2021/0025435 A1
(43) Pub. Date: Jan. 28, 2021

(54) LOCKNUT STRUCTURE FOR PUSH ROD

(71) Applicant: TOMUU ACTUATOR TECHNOLOGY CO.LTD, Dongguan (CN)

(72) Inventor: Hui Liu, Zhongshan (CN)

(21) Appl. No.: 17/070,954

(22) Filed: Oct. 15, 2020

(30) Foreign Application Priority Data
Aug. 7, 2020 (CN) 202021637547.X

(51) Int. Cl. F16B 39/12

(52) U.S. Cl. CPC F16B 39/12

(57) ABSTRACT

The present application provides a locknut structure for a push rod. A lock gasket of an annular structure is additionally arranged and is integrally formed with several clamping teeth in a circumferential direction of the lock gasket. A surface of a locknut is provided with clamping-tooth fitting grooves corresponding to the clamping teeth. If a load is too large, and the locknut is loosened and rotates relative to a lead screw, the clamping teeth will abut against inner walls of the corresponding clamping-tooth fitting grooves since the clamping teeth are fitted into the clamping-tooth fitting grooves, thereby restricting the rotation of the locknut to achieve permanent lock.

### TECHNICAL FIELD

The present utility model relates to the field of lockouts, and in particular to a locknut structure for a push rod

### BACKGROUND

In the prior art, a double-nut structure formed by matching a bearing nut and a locknut is used inside an electric push rod, but if a load is too large and the locknut is not glued or less glued, the locknut will be loosened backwards, and then a gap is enlarged, causing the structure to be loosened.

### SUMMARY

To solve the problem mentioned above, the present utility model provides a locknut structure for a push rod, due to the fact that clamping teeth of a lock gasket are fitted into clamping-tooth fitting grooves of a locknut, when the locknut rotates, inner walls of the clamping-tooth fitting grooves abut against corresponding clamping teeth, such that the rotation of the locknut are limited to achieve permanent lock.

To achieve the objective mentioned above, the present utility model adopts the following technical solution: A locknut structure for a push rod includes a locknut threadedly fitted on a lead screw and located on one side of a bearing nut, and the lock gasket fixedly sleeved on the lead screw and located on one side of the locknut away from the bearing nut, wherein the lock gasket is of an annular structure and are integrally formed with several clamping teeth in a circumferential direction of the lock gasket; a surface of the locknut close to the lock gasket is provided with clamping-tooth fitting grooves corresponding to the clamping teeth; and the clamping teeth on the lock gasket are clamped into the clamping-tooth fitting grooves in the locknut, and when the locknut rotates, inner walls of the clamping-tooth fitting grooves abut against the clamping teeth of the lock gasket to achieve limit.

Preferably, the lock gasket is provided with a flat hole in the center thereof, wherein the flat hole includes a first arc side located at an upper end, a second arc side located at a lower end, a first vertical side located on a left side, and a second vertical side located on a right side, and the first arc side, the second arc side, the first vertical side and the second vertical side define the flat hole in an enclosing manner.

Preferably, the clamping teeth have a thickness matching a depth of the clamping-tooth fitting grooves.

Preferably, the several clamping teeth are equidistantly distributed in the circumferential direction of the lock gasket.

Preferably, the clamping-tooth fitting grooves have a width larger than that of the clamping teeth.

The present utility model has the beneficial effects that the structure of the locknut is innovatively modified in the present application. Firstly, the lock gasket is additionally arranged, and the lock gasket is of the annular structure and are integrally formed with several clamping teeth in the circumferential direction of the lock gasket; secondly, the surface of the locknut is provided with the clamping-tooth fitting grooves corresponding to the clamping teeth; that is to say, if a load is too large, the locknut is loosened, rotates relative to the lead screw (normally, the locknut should be static relative to the lead screw), and moves in a length direction of the lead screw, but due to the fact that the clamping teeth of the lock gasket are fitted into the clamping-tooth fitting grooves of the locknut, when the locknut rotates, the inner walls of the clamping-tooth fitting grooves abut against the corresponding clamping teeth, such that the rotation of the locknut is limited to achieve permanent lock. Thus, according to the present application, the phenomenon that the locknut is loosened backwards, causing the structure to be loosened can be effectively prevented.

### BRIEF DESCRIPTION OF THE DRAWINGS

FIG. 1 is a schematic structural view of a locknut.

FIG. 2 is a schematic structural view of a lock gasket.

FIG. 3 is a sectional view of an electric push rod using the locknut structure for the push rod in the present application.

FIG. 4 is an enlarged schematic structural view of section A in FIG. 3.

Reference numerals: 1: locknut; 11: clamping-tooth fitting groove; 2: lock gasket; 21: clamping tooth; 22: flat hole; 3: lead screw; 31: flat shaft; 4: bearing nut; 5: driving gear; and 6: screw.

### DETAILED DESCRIPTION

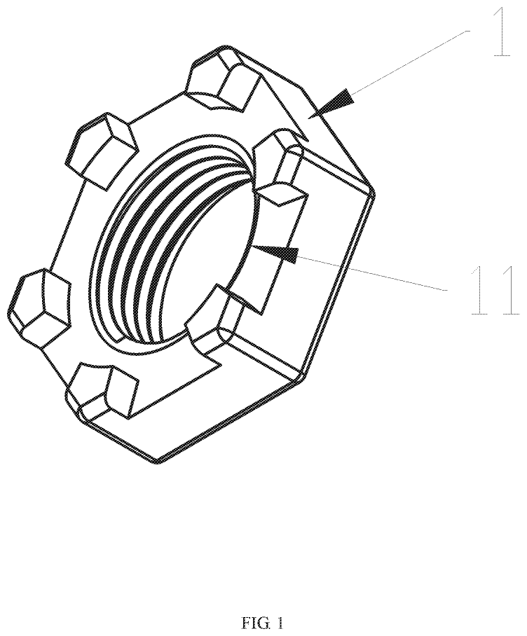

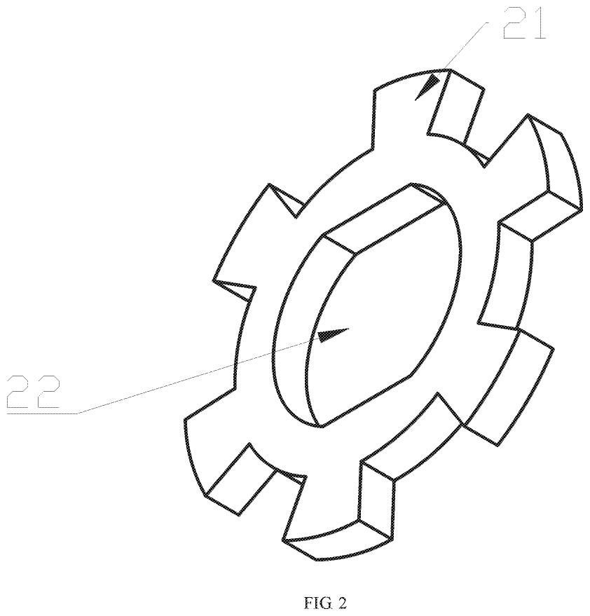

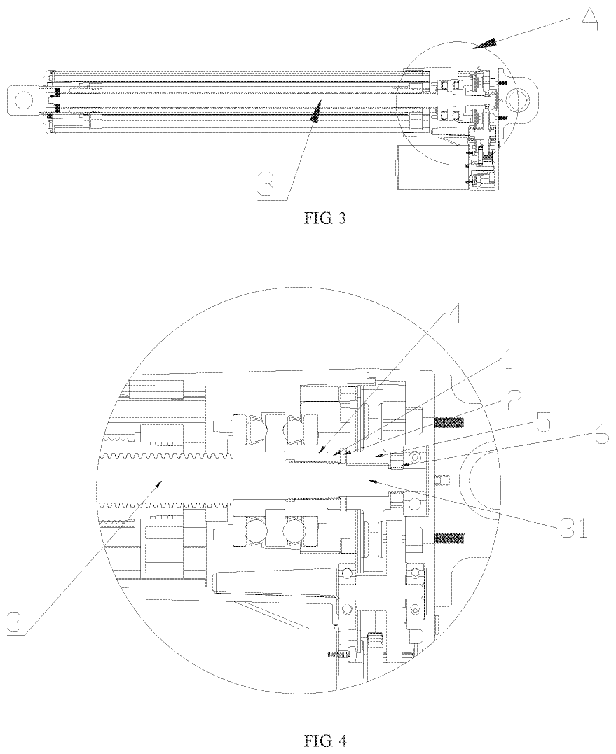

With reference to FIGS. 1-4, the present utility model relates to a locknut structure for a push rod, including a locknut 1 threadedly fitted on a lead screw 3 and located on one side of a bearing nut 4, and a lock gasket 2 fixedly sleeved on the lead screw 3 and located on one side of the locknut 1 away from the bearing nut 4. The lock gasket 2 is of an annular structure and is integrally formed with several clamping teeth 21 in a circumferential direction of the lock gasket 2. A surface of the locknut 1 close to the lock gasket 2 is provided with clamping-tooth fitting grooves 11 corresponding to the clamping teeth 21. The clamping teeth 21 on the lock gasket 2 are clamped into the clamping-tooth fitting grooves 11 in the locknut 1. When the locknut 1 rotates, inner walls of the clamping-tooth fitting grooves 11 abut against the clamping teeth 21 of the lock gasket 2 to achieve limit.

The structure of the locknut 1 is innovatively modified in the present application. Firstly, the lock gasket 2 is additionally arranged, and the lock gasket 2 is of the annular structure and is integrally formed with several clamping teeth 21 in the circumferential direction of the lock gasket 2. Secondly, the surface of the locknut 1 is provided with the clamping-tooth fitting grooves 11 corresponding to the clamping teeth 21; that is to say, if a load is too large, the locknut 1 is loosened, rotates relative to the lead screw 3 (normally, the locknut 1 should be static relative to the lead screw 3), and moves in a length direction of the lead screw 3; but due to the fact that the clamping teeth of the lock gasket 2 are fitted into the clamping-tooth fitting grooves 11 of the locknut 1, when the locknut 1 rotates, the inner walls of the clamping-tooth fitting grooves 11 abut against the corresponding clamping teeth 21, such that the rotation of the locknut 1 may be limited to achieve permanent lock. Thus, according to the present application, the phenomenon that the locknut is loosened backwards; causing the structure to be loosened can be effectively prevented.

Preferably, the lock gasket 2 is provided with a flat hole 22 in the center thereof. The flat hole 22 includes a first arc side located at an upper end, a second arc side located at a lower end, a first vertical side located on a left side; and a second vertical side located on a right side, and the first arc side, the second arc side, the first vertical side and the second vertical side define the flat hole 22 in an enclosing manner. During assembly, due to the presence of the flat hole 22, the lock gasket 2 may move in the length direction of the lead screw 3, but cannot rotate. Besides, a tail end of the lead screw 3 is provided with a flat shaft 31 used for assembling of the lock gasket 2 and a driving gear 5, and a longitudinal section of the flat shaft 31 corresponds to a shape of the flat hole 22. Of course, a user may arrange a corresponding flat hole 22 in the center of the lock gasket 2 according to different longitudinal sections of the flat shaft 31; such that the lock gasket 2 can be conveniently assembled on the lead screw 3. Meanwhile, since the driving gear 5 is assembled on the flat shaft 31 of the lead screw 3 and is locked by a screw 6 to be fixed on the lead screw 3, and one side of the driving gear 5 is tightly attached to one side of the lock gasket 2, the movement of the lock gasket 2 in the length direction of the lead screw 3 is limited. Thus, the driving gear 5 abuts against the lock gasket 2 to prevent the locknut 1 from driving the lock gasket 2 to move backward, and meanwhile a rear side of the driving gear 5 is locked by means of the screw 6, which prevents loosening of the driving gear 5.

Preferably, the clamping teeth 21 have a thickness matching a depth of the clamping-tooth fitting grooves 11. In this specific embodiment, the thickness of the clamping teeth 21 is designed to match the depth of the clamping-tooth fitting groove 11, such that the clamping teeth 21 can be effectively clamped into the clamping-tooth fitting grooves 11.

Preferably, in order to ensure that the center of gravity of the lock gasket 2 is located at the center thereof, in this specific embodiment, the several clamping teeth 21 are equidistantly, distributed in the circumferential direction of the lock gasket 2, such that when the lock gasket 2 rotates along with the lead screw 3, it can be avoided that swinging is caused due to the fact that the center of gravity of the lock gasket do not coincide with an axis of the lead screw 3.

Similarly, in order to ensure that the center of gravity of the locknut 1 is located at the center, the clamping-tooth fitting grooves 11 are equidistantly distributed in the circumferential direction of the surface of the locknut 1, such that when the locknut 1 rotates along with the lead screw 3, it can be avoided that swinging is caused due to the fact that the center of gravity of the locknut do not coincide with the axis of the lead screw 3.

Preferably, the width of the clamping-tooth fitting grooves 11 is larger than the width of the clamping teeth 21. A certain space is reserved between the clamping tooth 21 and the clamping-tooth fitting groove 11 for buffering; and if no buffering space is reserved between the clamping tooth 21 and the clamping-tooth fitting groove 11, after the locknut 1 is loosened, the clamping tooth 21 is directly stressed, resulting in damage to the clamping tooth 21 after a long time.

The above embodiments only describe the preferred embodiments of the present utility model and are not intended to limit the scope of the present utility model. Various modifications and improvements made to the technical solution of the present utility model by those of ordinary skill in the art without departing from the design and spirit of the utility model should fall within the scope of protection defined by the claims of the present utility model.

1. A locknut structure for a push rod, comprising a locknut threadedly fitted on a lead screw and located on one side of a bearing nut, and a lock gasket fixedly sleeved on the lead screw and located on one side of the locknut away from the bearing nut, wherein the lock gasket is of an annular structure and is integrally formed with several clamping teeth in a circumferential direction of the lock gasket, and a surface of the locknut close to the lock gasket is provided with clamping-tooth fitting grooves corresponding to the clamping teeth, the clamping teeth on the lock gasket are clamped into the clamping-tooth fitting grooves in the locknut, and when the locknut rotates, inner walls of the clamping-tooth fitting grooves abut against the clamping teeth of the lock gasket to achieve limit.

2. The locknut structure for the push rod according to claim 1, wherein the lock gasket is provided with a flat hole in the center thereof, the flat hole comprises a first arc side located at an upper end, a second arc side located at a lower end, a first vertical side located on a left side, and a second vertical side located on a right side, the first arc side, and the second arc side, the first vertical side and the second vertical side define the flat hole in an enclosing manner.

3. The locknut structure for the push rod according to claim 1, wherein the clamping teeth have a thickness matching a depth of the clamping-tooth fitting grooves.

4. The locknut structure for the push rod according to claim 1, wherein the several clamping teeth are equidistantly distributed in the circumferential direction of the lock gasket, and the clamping-tooth fitting grooves are equidistantly distributed in the circumferential direction of a surface of the locknut.

5. The locknut structure for the push rod according to claim 1, wherein the clamping-tooth fitting grooves have a width larger than that of the clamping teeth.
